(19) United States
(12) Patent Application Publication
(10) Pub. No.: US 2017/0073953 A1
(43) Pub. Date: Mar. 16, 2017

(54) NOZZLE ASSEMBLY AND METHOD OF CONTROLLING THE SAME

(71) Applicant: Shanghai Kohler Electronics, Ltd., Shanghai (CN)

(72) Inventors: Yejun Gu, Shanghai (CN); Bo Hu, Shanghai (CN)

(21) Appl. No.: 15/260,038

(22) Filed: Sep. 8, 2016

(30) Foreign Application Priority Data
Sep. 10, 2015 (CN) 201510574456.3

(51) Int. Cl. E03D 9/08; B05B 15/02; B05B 12/14; A47K 7/08

(52) U.S. Cl. CPC E03D 9/08; A47K 7/08; B05B 15/025; B05B 12/14

(57) ABSTRACT

A nozzle assembly including water and gas supply units, a jet pipe having a nozzle for spraying water and/or gas, and a supply pipeline. The supply pipeline includes a first end fluidly connected with the nozzle and a second end fluidly connected with the water and gas supply units. The water supply unit has an open state, in which water is supplied to the supply pipeline, and a closed state. The gas supply unit has an open state, in which a gas is supplied to the supply pipeline, and a closed state. After the water supply unit is switched from the open state to the closed state, the gas supply unit is automatically switched from the closed state to the open state and is maintained in the open state for a preset time, after which the gas supply unit is switched to the closed state.

### CROSS-REFERENCE TO RELATED PATENT APPLICATIONS

The present application claims the benefit and priority to Chinese Patent Application No. 201510574456.3, filed Sep. 9, 2015, which is incorporated herein by reference in its entirety.

### BACKGROUND

The present application relates to the technical field of toilet parts and components, and in particular to a nozzle assembly capable of preventing blockage and a control method thereof.

Nozzle is a part used in an intelligent toilet for washing human body and is typically formed by holes that are formed on a jet pipe. Since said plurality of holes are formed on a stainless steel nozzle shell through laser hole drilling, however, a small amount of burrs will remain on the hole wall and inner and outer sides of the holes due to the limitations of the process and equipment, and the holes do not have perfect roundness. Since the nozzle is formed by micro holes that have a small diameter, it is very difficult to ensure the roundness of the micro holes and to remove the burrs in the process.

Every time when cleaning is completed, water would remain on the hole wall, as well as the external surface and internal surface of the holes, and when they are not used for a long time, the remaining water would gradually turn into scales that block the holes, leading to a useless water form and shortening the service life of the nozzle.

### SUMMARY

According to one exemplary embodiment, a nozzle assembly for a toilet is provided. The nozzle assembly includes a water supply unit, a gas supply unit, a jet pipe having a front end that includes a nozzle for spraying at least one of water or gas, and a supply pipeline. The supply pipeline includes a first end, which is in fluid communication with the nozzle, and a second end, which is in fluid communication with the water supply unit and the gas supply unit. The water supply unit has an open state, in which water is supplied to the supply pipeline, and a closed state, in which water is not supplied to the supply pipeline. The gas supply unit has an open state, in which a gas is supplied to the supply pipeline, and a closed state, in which gas is not supplied to the supply pipeline. The nozzle assembly may be configured such that after the water supply unit is switched from the open state to the closed state, the gas supply unit is switched from the closed state to the open state and is maintained in the open state for a preset time, after which the gas supply unit is switched to the closed state.

According to another exemplary embodiment, a toilet includes a water supply unit, a gas supply unit, a nozzle assembly that selectively receives water from the water supply unit and gas from the gas supply unit, and a control unit. The nozzle assembly includes a jet pipe having a nozzle for selectively spraying water in a first mode and gas in a second mode and a supply pipeline fluidly connecting the nozzle with the water supply unit and the gas supply unit. The control unit controls operation of the water supply unit and the gas supply unit. In the first mode, the water supply unit is in an open state, in which water is supplied to the nozzle through the supply pipeline, and the gas supply unit is in a closed state, in which gas is not supplied to the supply pipeline. In the second mode, the water supply unit is in a closed state, in which water is not supplied to the supply pipeline, and the gas unit is in an open state, in which gas is supplied to the nozzle through the supply pipeline. After completion of the first mode, the control unit automatically switches to the second mode for a preset time then switches into a third mode, in which both the water supply unit and the gas supply unit are in the closed states.

According to yet another exemplary embodiment, a method for controlling a nozzle assembly for a toilet that is fluidly connected to a water supply unit and a gas supply unit. The method may include moving the water supply unit to an open state to supply water into a supply pipeline of the nozzle assembly, such that water is sprayed out through a nozzle of the nozzle assembly, which may occur after a preset condition is satisfied. The method may include moving the water supply unit from the open state to a closed state to stop supplying water into the supply pipeline. The method may include (with the water supply unit in the closed state) moving the gas supply unit to an open state to supply gas into the supply pipeline, such that gas is sprayed out through the nozzle. The method may include (after maintaining the gas supply unit in the open state for a preset time) moving the gas supply unit to a closed state to stop supplying the gas into the supply pipeline.

An exemplary object of the present application is to overcome the drawbacks of the prior art by providing a nozzle assembly that is capable of preventing nozzle blockage and extending the service life thereof and a control method thereof.

According to one example, the technical solution of the present application provides a nozzle assembly, including a jet pipe, a water supply unit and a gas supply unit; the front end of the jet pipe is provided with a nozzle for spraying water or spraying a gas, a supply pipeline is further provided within the jet pipe, one end of the supply pipeline is in communication with the nozzle, and the other end thereof is in communication with the water supply unit and the gas supply unit, respectively; the water supply unit has an opening state in which water is supplied into the supply pipeline and a closed state in which water supply is stopped into the supply pipeline; the gas supply unit has an opening state in which a gas is supplied into the supply pipeline and a closed state in which gas supply is stopped into the supply pipeline; wherein, every time when the water supply unit is switched from the opening state to the closed state, the gas supply unit is switched from the closed state to the opening state, and after being maintained in the state for a preset time, is switched to the closed state.

Furthermore, the preset time may be between 5 s and 30 s.

Furthermore, the nozzle may include a plurality of j et holes arranged in an array. The jet holes may have a diameter that is greater than 0 mm and less than or equal to 0.4 mm.

Furthermore, the front end of the jet pipe may have an inclined surface, and the distance between the inclined surface and the axis of the jet pipe increases gradually in the direction from the front end to the rear end of the jet pipe. The jet holes may be through holes on the inclined surface, and the axes of the jet holes may be perpendicular (or oblique) to the inclined surface.

Furthermore, the gas supply unit may include a gas pump.

Furthermore, a control unit may be provided in the nozzle assembly for controlling the water supply unit and the gas supply unit.

Furthermore, the jet pipe may include a rotating washing hole and/or a buttock washing hole. The rotating washing hole and/or the buttock washing hole may be connected to the water supply unit through two mutually independent water supply pipelines, respectively.

According to another example, the technical solution of the present application may include a four step control method for controlling the nozzle assembly. The control method may include the following four steps: S01: when a preset condition is satisfied, the water supply unit is turned on to be in the open state (e.g., opening state) to supply water into the supply pipeline and to spray water out through the nozzle; S02: when water supply is completed, the water supply unit is moved to the closed state to stop the operation of the unit, which stops supplying water into the supply pipeline; S03: when the water supply unit is in the closed state, the gas supply unit is turned on to be in the open state (e.g., opening state) to supply a gas into the supply pipeline, such that the gas is sprayed out through the nozzle; S04: after being maintained in the open state for a preset time, the gas supply unit is moved to the closed state to stop the operation of the unit, which stops supplying the gas into the supply pipeline.

Furthermore, the preset time may range from 5 s to 30 s.

Furthermore, the nozzle include a plurality of jet holes arranged in an array, with each jet hole having a diameter ranging from 0 to 0.4 mm. Both water and the gas can be selectively sprayed out through each jet hole, depending on the mode of operation.

The above technical solution provides several beneficial effects, one of which is that every time when the water supply unit completes the operation, namely the cleaning is completed, the gas supply unit is used to supply a gas into the supply pipeline, the gas is sprayed out through the nozzle, such that the water remaining on the pipe wall of the supply pipeline, the external surface and internal surface of the nozzle is blow-dried by the gas to prevent the formation of scales. The drying greatly reduces the risk that the nozzle is blocked and extending the service life of the nozzle.

Therefore, the nozzle assembly and the control method thereof according to the present application are capable of preventing nozzle blockage, have simple operations, and extend the service life of the nozzle.

### BRIEF DESCRIPTION OF THE DRAWINGS

FIG. 1 is a schematic view of the nozzle assembly, according to the present application.

FIG. 2 is a perspective view of a jet pipe for use with the nozzle assembly shown in FIG. 1.

FIG. 3 is an enlarged view of a nozzle of the jet pipe shown in FIG. 2.

FIG. 4 is a cross-sectional view of the jet pipe shown in FIG. 2.

FIG. 5 is a schematic view of the jet pipe shown in FIG. 2 connected to the water supply unit and the gas supply line.

FIG. 6 is a flow chart of an exemplary embodiment of a control method, according to the present application.

### DETAILED DESCRIPTION

Specific embodiments of the present application will be further described below with reference to the accompanying drawings, wherein the same parts are represented by the same legends (e.g., reference numerals, terms, etc.).

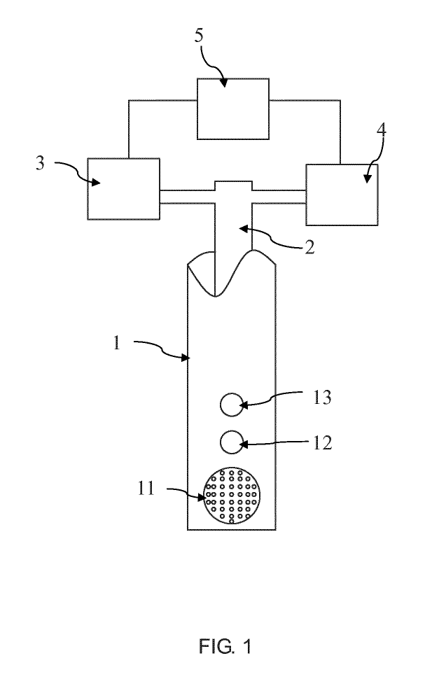

FIGS. 1-5 illustrate a nozzle assembly for a toilet, according to an exemplary embodiment of the present application, that includes a jet pipe 1, a water supply unit 3 and a gas supply unit 4.

A first (e.g., front) end 15 of the jet pipe 1 is provided with a nozzle 11 for spraying water or spraying a gas, which may be received through a supply pipeline 2 that is provided within the jet pipe 1. One end (e.g., a first end) of the supply pipeline 2 is in fluid communication with the nozzle 11, and the other end (e.g., a second end) of the supply pipeline 2 is in fluid communication with the water supply unit 3 and the gas supply unit 4.

The water supply unit 3 has an open state (e.g., opening state), in which water is supplied into the supply pipeline 2, and a closed state, in which water supply is stopped (i.e., not supplied into the supply pipeline 2). In other words, the water supply unit 3 is operable in the open state or the closed state to control the supply of water to the supply pipeline 2.

The gas supply unit 4 has an open state (e.g., opening state), in which a gas is supplied into the supply pipeline 2, and a closed state, in which gas supply is stopped (i.e., not supplied into the supply pipeline 2). In other words, the gas supply unit 4 is operable in the open state or the closed state to control the supply of gas to the supply pipeline 2.

According to one example, the nozzle assembly is configured such that every time the water supply unit 3 is switched from the open state to the closed state, the gas supply unit 4 is switched from the closed state to the open state, and after being maintained in the open state for a preset time (e.g., predetermined time, amount of time, etc.), is switched to the closed state. For example, the gas supply unit 4 may automatically switch from the open state to the closed state after the preset time.

According to one example, the nozzle assembly is mainly used for installation on a toilet, which sprays out water through the nozzle 11 thereon for washing a designated part of a human body (e.g., seated on the toilet). The nozzle assembly may include the jet pipe 1, the nozzle 11, the supply pipeline 2, the water supply unit 3, and the gas supply unit 4.

As shown in FIGS. 1 and 5, the nozzle 11 is located (e.g., formed) at the front end of the jet pipe 1, one end of the supply pipeline 2 is in communication (e.g., fluid communication) with the nozzle 11, and the other end of the supply pipeline 2 is in communication with the water supply unit 3 and the gas supply unit 4, respectively.

Each of the water supply unit 3 and the gas supply unit 4 has an open state and a closed state. When the water supply unit 3 is in the open state, water is supplied from the water supply unit 3 into the supply pipeline 2, and water may be sprayed out through the nozzle 11, such as to wash a designated part of human body. When the water supply unit 3 is in the closed state, the water supply unit 3 stops supplying water into the supply pipeline 2, such as indicating that washing is completed.

When the gas supply unit 4 is in the open state, gas is supplied from the gas supply unit 4 into the supply pipeline 2. The gas flows through the supply pipeline 2 and then is sprayed out through the nozzle 11. By way of example, in the open state, the gas from the gas supply unit 4 can blow dry the water remaining on the internal and external surfaces of the nozzle 11 and on the pipe wall during the water spraying process, so as to prevent the formation of scales. This may advantageously greatly reduce the risk that the nozzle 11 is blocked and may advantageously extend the service life of the nozzle 11.

When the gas supply unit 4 is in the closed state, the gas supply unit 4 stops supplying the gas into the supply pipeline 2, which may indicate that the blow-drying of the remaining water is completed.

To realize that there is no mutual interference between the water supply unit 3 and the gas supply unit 4, and to ensure that the remaining water will be blow-dried or dried every time (e.g., after every use of the water supply unit 3), the nozzle assembly may be configured to operate (e.g., steps may be performed) in the following manner:

Every time when the water supply unit 3 is switched from the open state to the closed state, the gas supply unit 4 is switched from the closed state to the open state, and after maintaining the gas supply unit 4 in the open state for a preset time, the gas supply unit 4 is then switched to the closed state.

In such a way, the nozzle assembly can ensure that, every time when the water supply unit 3 completes the operation, namely the cleaning is completed, the gas supply unit 4 is used to supply a gas into the supply pipeline 2. As noted, the gas may be sprayed out through the nozzle 11, such that the water remaining on the pipe wall (e.g., inside surface of the wall) of the supply pipeline 2. The external surface and/or internal surface of the nozzle 11 may be blow-dried by the gas to prevent the formation of scales, such as to greatly reducing the risk that the nozzle is blocked and extending the service life of the nozzle.

Opening and closing of the water supply unit 3 and the gas supply unit 4 may be controlled through a controller (e.g., the control unit 5 discussed below). The controller may be a mechanically controlled structure or an electronically controlled structure (e.g., through software and/or a microprocessor) that is configured to ensure that the gas supply unit 4 starts to operate every time when the water supply unit 3 completes the operation. The controller may control the opening/closing of the water supply unit 3 and/or the opening/closing of the gas supply unit 4. For example, the controller may control the timing cycle of the nozzle assembly to control when each supply unit opens/closes.

The gas supply unit 4 may be configured to start to operate immediately when the water supply unit 3 stops the operation (e.g., closes), or may start to operate after a certain period of time has passed (e.g., a time delay) following closing of the water supply unit 3.

According to one example, the water supply unit 3 includes a water tank that supplies water for cleaning/washing and/or for flush cycles of the toilet (or a part of the water tank). According to another example, the water supply unit 3 is separate from (e.g., a separate part) the water tank that supplies the water for flush cycles.

According to one example, the preset time is from 5 s to 30 s. That is, after maintaining the gas supply unit 4 in the open state for a time that is from 5 s to 30 s, the gas supply unit 4 is switched to the closed state. This setting also provides the advantage of operating along with other toilet operations. For example, when a toilet completes washing through the water supply unit 3, water is typically supplied into a water tank or the water supply unit 3 (e.g., through a water pump). The water supply duration is typically longer than 20 s, and during this period there is a noise. Further, a deodorizing module, if provided with the toilet, would typically begin operations to deodorize after the water supply unit 3 completes washing with a typical duration of 30 s, during which period there is also a noise. Therefore, any noise produced by the gas supply unit 4, such as while in the operating state (e.g., open state), would be masked by the noise of the other operations, such as those discussed above.

If the gas supply unit 4 is still in the open state after the water pump finishes supplying water and the deodorizing operation is completed, then the toilet may have (e.g., emit) a noise after water supply and deodorizing operation are completed that could be objectionable to a user, which may make the assembly unfavorable for use.

By setting the preset time from 5 s to 30 s, on the other hand, the water pump is supplying water and the deodorizing module, if provided, is also running when the gas supply unit 4 is operating (e.g., in the open state). Accordingly, the noise from the three systems/assemblies takes place during this same time period, and the toilet will not have a noise after the water pump finishes water supply and the deodorizing operation is completed.

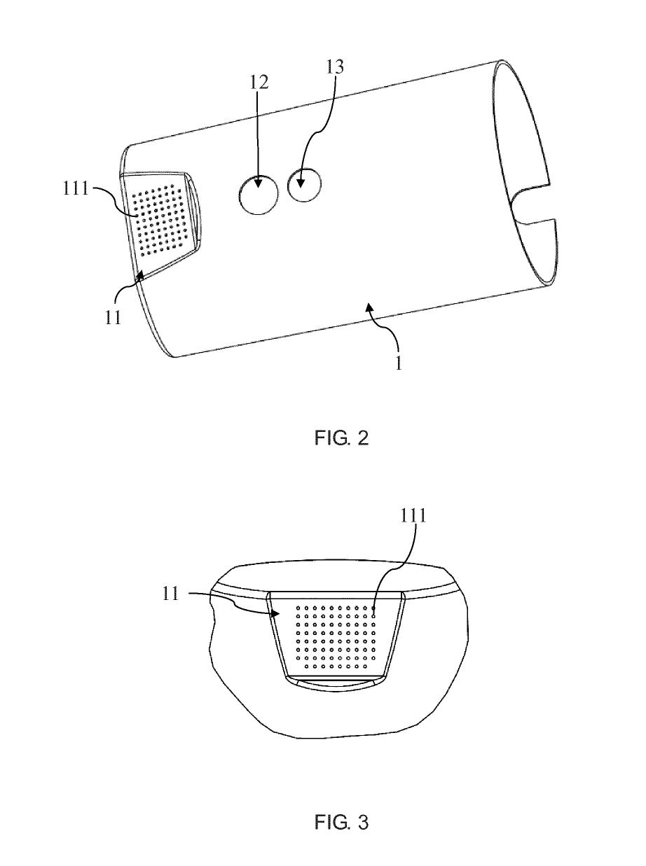

As shown in FIGS. 2-4, the nozzle 11 includes a plurality of jet holes 111 arranged in an array. According to one example, each jet hole 111 has a diameter that is greater than 0 mm and less than or equal to 0.4 mm. By configuring the nozzle 11 with a plurality of jet holes 111 arranged in an array and having a diameter that is smaller than or equal to 0.4 mm, the washing comfort and softness of the water sprayed from the holes 111 may be particularly suitable for females.

The jet holes 111 of such a relative small size (e.g., less than 0.4 mm) tend to be prone to blockage (e.g., by scale). However, providing a gas supply unit 4 that introduces a gas that is sprayed out of the jet pipe 1 through the jet holes 111 may prevent the build-up of scale and/or remove scale that has built up. In once such process, the gas blow-dries or carries away the water remaining on the wall of the jet pipe 1, the internal and external surfaces of the jet holes 111 and the wall of the jet holes, to prevent the formation of scale and blockage of the jet holes 111. This process may also remove scale that has built up on these features (e.g., the walls, internal and external surfaces, etc.).

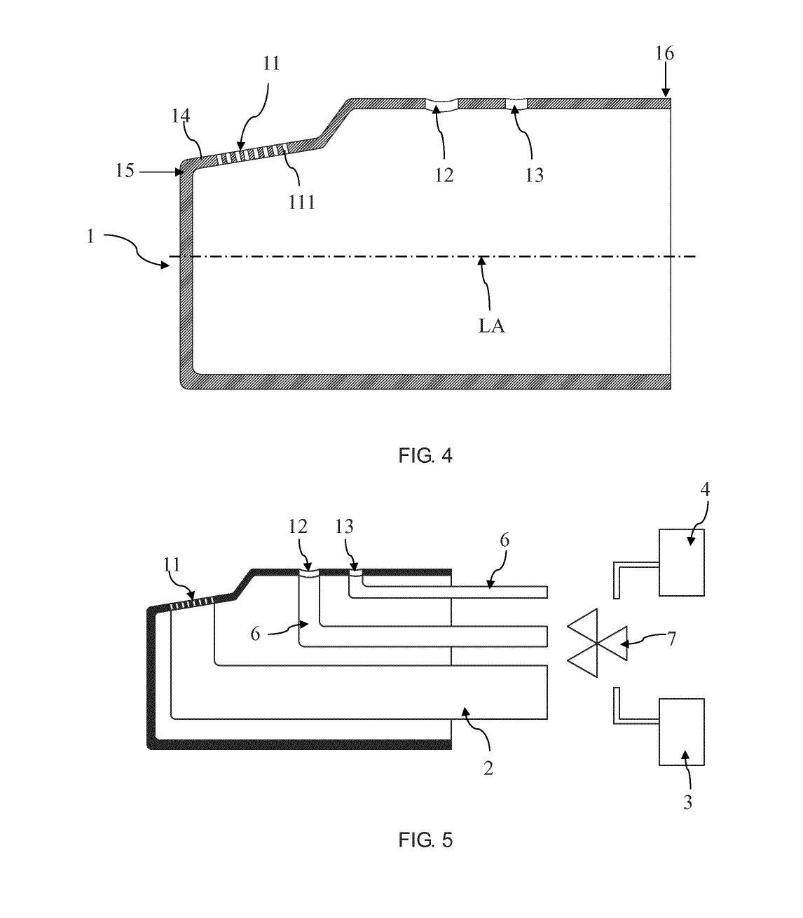

As shown in FIG. 4, the front end 15 of the jet pipe 1 has an inclined surface 14, and the distance between the inclined surface 14 and a longitudinal axis LA of the jet pipe 1 increases gradually in the direction from the front end 15 to the rear end 16 of the jet pipe 1. The jet holes 111 may be formed as through jet holes on the inclined surface 14, such that the axis of each jet hole 111 is generally perpendicular to the inclined surface 14. The axis of each jet hole 111 may also be arranged at an oblique (e.g., non-perpendicular) angle relative to the longitudinal axis LA. By providing the inclined surface 14 on the front end of the jet pipe 1, and configuring the inclined surface 14 to tilt upward gradually in the direction from the front end 15 to the rear end 16 of the jet pipe 1, and/or by providing the jet holes 111 perpendicularly on the inclined surface 14 such that the axes of the jet holes 111 are perpendicular to the inclined surface 14, it can ensure that, during use, the jet holes 111 spray water in a direction that is inclined way upward to the front, thereby facilitating the washing of a designated part of a human body. For example, this arrangement may be particularly suitable for females.

The front end 15, as used herein, refers to the end of the jet pipe 1 that is toward (e.g., faces) a human body during use, while the rear end 16, as used herein, refers to the end opposite to the front end 15, such as the end that is toward the water and/or gas supplies 3, 4.

According to one example, the gas supply unit 4 is a gas pump. For convenience of material supply, the gas supply unit 4 can directly use the gas pump in an existing toilet without specially adding other parts, which reduces the assembly cost.

The nozzle assembly may include a control unit (e.g., a controller). As shown in FIG. 1, a control unit 5 is further provided for controlling the water supply unit 3 and the gas supply unit 4, such as to control the timing and amount of water/gas that is supplied to the jet pipe 1. By way of example, the control unit 5 may be configured to control the opening/closing of the water supply unit 3 and/or the gas supply unit 4, such as by turning on and off each unit, to thereby control the flow of water/gas to the nozzle 11. Further, the control unit 5 may be configured to control any of the functions of the nozzle assemblies disclosed herein. Such control can be achieved, for example, by making use of the hardware system and changing the software system in an existing toilet, with no need to perform significant transformation on the toilet. This advantageously allows for an existing toilet to be retrofitted with a nozzle assembly as a reduced cost (e.g., relative to buying a new toilet having such a nozzle assembly).

The nozzle assembly may be configured having additional nozzles/holes for providing additional washing functionality. As shown in FIGS. 1, 2, 4 and 5, the jet pipe 1 may further include a rotating washing hole 12 and/or a buttock washing hole 13. The rotating washing hole 12 and the buttock washing hole 13 are connected to the water supply unit 3 through two mutually independent water supply pipelines 6, respectively, such that each hole 13, 14 is in fluid communication with water from the water supply unit 3.

The rotating washing hole 12 and the buttock washing hole 13 may be sequentially disposed between the nozzle 11 and the rear end 16, such as on a surface above the inclined surface 14. This arrangement can satisfy different functional requirements. By way of example, the rotating washing hole 12 may be used for spraying a rotating water form, and the buttock washing hole 13 may be used for washing human buttocks, in order to satisfy different needs.

As shown in FIG. 5, the rotating washing hole 12 and the buttock washing hole 13 are connected to the water supply unit 3 through two mutually independent water supply pipelines 6, respectively, which can achieve independent operations without interfering with each other.

The nozzle assembly having the rotating washing hole 12 and/or the buttock washing hole 13 may include a device for selectively connecting one of the fluids (e.g., water, gas) with one or more of the holes 12, 13 and/or nozzle 11. As shown in FIG. 5, the nozzle assembly includes a distributor 7, and the water supply unit 3 and the gas supply unit 4 are connected with and disconnected from the supply pipeline 2 and the water supply pipelines 6 through the distributor 7. For example, the distributor 7 may route water to the supply pipeline 2 in a first mode (e.g., of operation), may route water to the pipeline 6 supplying the rotating washing hole 12 in a second mode, and may route water to the pipeline 6 supplying the buttock washing hole 13 is a third mode.

According to one example, the rotating washing hole 12 and the buttock washing hole 13 are configured to receive only water from the water supply unit 3. According to another example, the rotating washing hole 12 and the buttock washing hole 13 are configured to receive water from the water supply unit 3 and gas from the gas supply unit 4. The distributor 7 may be configured to selectively route the water and/or the gas to the selected nozzle 11 or hole 12, 13. For example, the nozzle assembly may be configured to route gas from the gas supply unit 4 through the water supply pipelines 6, such as after the water supply unit 3 stops supplying water into the water supply pipelines 6. This arrangement may advantageously blow dry or dry the water on the rotating washing hole 12 and/or the buttock washing hole 13, which, on one hand, can improve the comfort of use, and on the other hand, can also prevent blockage. The control unit 5 may control the distributor 7, such as by controlling the mode in which the distributor 7 operates in to control routing of the fluid (e.g., water, gas) through the assembly.

The nozzle assembly, according to the present application, has a simple structure and is easy to operate. The nozzle assembly can be configured to prevent blockage of the nozzle and extend the service life of the nozzle.

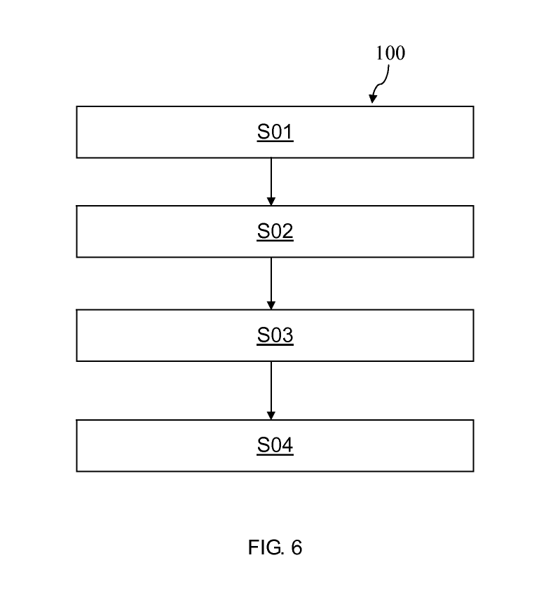

FIG. 6 illustrates a control method for controlling the nozzle assembly, according to one embodiment of the present application, that includes four steps, S01, S02, S03, and S04.

During the step S01, which is shown as the first step in FIG. 6, the water supply unit 3 is turned on to be in the open state to supply water into the supply pipeline 2. Water supplied to the supply pipeline 2 is sprayed out through the nozzle 11. The first step S01 can be initiated after a preset condition is satisfied. By way of example, the preset condition may include activating the nozzle assembly, such as through an actuator, which may be manually activated (e.g., button, switch, lever, etc.) or electronically activated (e.g., a touchscreen, etc.) or combination thereof.

During the step S02, which is shown as the second step in FIG. 6, when the water supply is completed, the water supply unit 3 stops the operation by moving to the closed state to thereby stop supplying water into the supply pipeline 2.

During the step S03, which is shown as the third step in FIG. 6, when the water supply unit 3 is in the closed state, the gas supply unit 4 is turned on to be in the open state to supply gas into the supply pipeline 2. The gas supplied to the supply pipeline 2 is sprayed out through the nozzle 11.

During the step S04, which is shown as the fourth step in FIG. 6, after being maintained in the open state for a preset time, the gas supply unit 4 stops the operation by moving to the closed state to thereby stop supplying gas into the supply pipeline 2. The preset time can be tailored to the specific application (e.g., function of the specific toilet in which the nozzle assembly is employed).

In such a way, it can realize that, every time when the water supply unit 3 completes the operation, such as after completing the cleaning, the gas supply unit 4 is used to supply a gas into the supply pipeline 2. The gas is sprayed out through the nozzle 11, such that the water remaining on the pipe wall of the supply pipeline 2, the external surface and internal surface of the nozzle 11 is blow-dried by the gas to prevent the formation of scales. The drying greatly reduces the risk that the nozzle is blocked and extending the service life of the nozzle.

According to an exemplary embodiment, the preset time is from 5 s to 30 s. That is, after being maintained in the open state from 5 s to 30 s, the gas supply unit 4 is then switched (from the open state) to the closed state. Such a setting is advantageous. When a toilet completes washing through the water supply unit 3, it typically needs to supply water into a water tank or the water supply unit 3 via a water pump, and the water supply duration thereof is typically longer than 20 s, during which period there is a noise. Further, a deodorizing module, if provided on the toilet, would typically begin operating to deodorize after the water supply unit 3 completes washing with a typical duration of about 30 s, during which period there is also a noise. The gas supply unit 4 may produce a noise during operation (e.g., in the open state), which advantageously is configured to overlap with the operating times of the water supply (e.g., a fill time of the water pump) and/or the deodorizing module to confine the noises from these devices to this period of time.

If the gas supply unit 4 is still in the operating state after the water pump finishes water supply and the deodorizing operation is completed, the toilet will still have a noise after water supply and deodorizing operation are completed, which could be objectionable to some users.

By setting the preset time from 5 s to 30 s, on the other hand, the water pump is supplying water and the deodorizing module is also running when the gas supply unit 4 is operating, such that the noise from the three devices takes place during the same time period, and the toilet will not have a noise after the water pump finishes water supply and the deodorizing operation is completed.

The nozzle 11 may include one hole or a plurality of jet holes 111 arranged in an array Each the jet hole 111 may have a diameter that is greater than 0 mm and less than or equal to about 0.4 mm, which may be advantageous for the spray pattern of water emitted. Both water and the gas may be sprayed out through the jet holes 111, depending on the function (e.g., mode) that the nozzle assembly is operating in.

By arranging the nozzle 11 with a plurality of jet holes 111 having diameters no bigger than 0.4 mm and arranged in an array, the washing comfort and softness of the sprayed water (e.g., the spray pattern formed by the water emitted through the plurality of jet holes 111) may be particularly suitable for females.

The jet holes 111 of such a small size (e.g., no bigger than 0.4 mm) are more prone to be blocked by scale. The gas supply unit 4 advantageously introduces a gas that is sprayed out of the jet pipe 1 through the jet holes 111 to blow-dry and/or carry away any water remaining on the wall of the jet pipe 1, the internal and external surfaces of the jet holes 111, and/or the wall of the jet holes. This may prevent the formation of scales and blockage of the jet holes 111.

The above technical solutions may be combined as needed to achieve optimal technical effects.

The above description is only the principle and preferred examples of the present application. It should be noted that a number of other variations may be made by those skilled in the art based on the principle of the present application.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “connected,” and the like, as used herein, mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that “front”, “rear”, “left”, “right”, “up”, and “down” used in the description may refer to the directions in the accompanying drawings, and the terms “inner” and “outer” refer to directions toward or away from, for example, a geometric center of a specific part. It should be noted that the orientation of various elements may differ according to other exemplary embodiments, and that such variations are intended to be encompassed by the present disclosure.

The construction and arrangement of the elements of the nozzle assemblies as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements, the position of elements may be reversed or otherwise varied, and the nature or number of discrete elements or positions may be altered or varied.

Additionally, the word “exemplary” is used to mean serving as an example, instance, or illustration. Any embodiment or design described herein as “exemplary” is not necessarily to be construed as preferred or advantageous over other embodiments or designs (and such term is not intended to connote that such embodiments are necessarily extraordinary or superlative examples). Rather, use of the word “exemplary” is intended to present concepts in a concrete manner. Accordingly, all such modifications are intended to be included within the scope of the present disclosure. Other substitutions, modifications, changes, and omissions may be made in the design, operating conditions, and arrangement of the preferred and other exemplary embodiments without departing from the scope of the appended claims.

Other substitutions, modifications, changes and omissions may also be made in the design, operating conditions and arrangement of the various exemplary embodiments without departing from the scope of the present invention. For example, any element (e.g., jet pipe, supply pipe, nozzle, supply unit, etc.) disclosed in one embodiment may be incorporated or utilized with any other embodiment disclosed herein. Also, for example, the order or sequence of any process or method steps may be varied or re-sequenced according to alternative embodiments. Any means-plus-function clause is intended to cover the structures described herein as performing the recited function and not only structural equivalents but also equivalent structures. Other substitutions, modifications, changes and omissions may be made in the design, operating configuration, and arrangement of the preferred and other exemplary embodiments without departing from the scope of the appended claims.

What is claimed is:

1. A nozzle assembly for a toilet, comprising:
a water supply unit;
a gas supply unit;
a jet pipe having a front end that includes a nozzle for spraying at least one of water or gas; and
a supply pipeline comprising:
a first end that is in fluid communication with the nozzle; and
a second end that is in fluid communication with the water supply unit and the gas supply unit;
wherein the water supply unit has an open state in which water is supplied to the supply pipeline and a closed state in which water is not supplied to the supply pipeline;
wherein the gas supply unit has an open state in which a gas is supplied to the supply pipeline and a closed state in which gas is not supplied to the supply pipeline; and
wherein after the water supply unit is switched from the open state to the closed state, the gas supply unit is switched from the closed state to the open state and is maintained in the open state for a preset time, after which the gas supply unit is switched to the closed state.

2. The nozzle assembly of claim 1, wherein the preset time is from 5 s to 30 s.

3. The nozzle assembly of claim 1, wherein the nozzle comprises a plurality of jet holes arranged in an array.

4. The nozzle assembly of claim 3, wherein each jet hole of the plurality of jet holes has a diameter that is no greater than 0.4 mm.

5. The nozzle assembly of claim 3, wherein the front end of the jet pipe has an inclined surface, and the distance between the inclined surface and the axis of the jet pipe increases gradually in the direction from the front end to a rear end of the jet pipe.

6. The nozzle assembly of claim 5, wherein each jet hole of the plurality of j et holes is a through hole in the inclined surface and each jet hole includes an axis that is perpendicular to the inclined surface.

7. The nozzle assembly of claim 1, wherein the gas supply unit is a gas pump.

8. The nozzle assembly of claim 1, further comprising a control unit for controlling the water supply unit and the gas supply unit.

9. The nozzle assembly of claim 1, wherein the supply pipeline is a first supply pipeline, and the jet pipe includes a rotating washing hole that is fluidly connected to the water supply unit through a second supply pipeline.

10. The nozzle assembly of claim 9, further comprising a distributor that selectively routes water to the first supply pipeline in a first mode and the second supply pipeline in a second mode.

11. The nozzle assembly of claim 9, wherein the jet pipe includes a buttock washing hole, and the buttock washing hole is fluidly connected to the water supply unit through a third supply pipeline, and wherein the second and third supply pipelines are mutually independent from one another.

12. The nozzle assembly of claim 11, further comprising a distributor that selectively routes water to the first supply pipeline in a first mode, the second supply pipeline in a second mode, and the third supply pipeline in a third mode.

13. A toilet, comprising:
a water supply unit;
a gas supply unit;
a nozzle assembly that selectively receives water from the water supply unit and gas from the gas supply unit, the nozzle assembly comprising:
a jet pipe having a nozzle for selectively spraying water in a first mode and gas in a second mode; and
a supply pipeline fluidly connecting the nozzle with the water supply unit and the gas supply unit; and
a control unit that controls operation of the water supply unit and the gas supply unit;
wherein in the first mode, the water supply unit is in an open state, in which water is supplied to the nozzle through the supply pipeline, and the gas supply unit is in a closed state, in which gas is not supplied to the supply pipeline;
wherein in the second mode, the water supply unit is in a closed state, in which water is not supplied to the supply pipeline, and the gas unit is in an open state, in which gas is supplied to the nozzle through the supply pipeline; and
wherein after completion of the first mode, the control unit automatically switches to the second mode for a preset time then switches into a third mode, in which both the water supply unit and the gas supply unit are in the closed states.

14. The toilet of claim 13, wherein the water supply unit includes a water tank, and the preset time overlaps with a fill time during which the water tank is refilled after completion of the first mode.

15. The toilet of claim 14, wherein the preset time is from 5 s to 30 s, and wherein the water tank also supplies water for a flush cycle of the toilet.

16. The toilet of claim 13, wherein the supply pipeline is a first supply pipeline, and the jet pipe further comprises:
a rotating washing hole that is fluidly connected to the water and gas supply units through a second supply pipeline; and
a buttock washing hole, and the buttock washing hole is fluidly connected to the water and gas supply units through a third supply pipeline;
wherein each supply pipeline is mutually independent from any other supply pipeline.

17. The toilet of claim 16, further comprising a distributor that selectively routes water and gas to each of the first, second and third supply pipelines.

18. A method for controlling a nozzle assembly for a toilet that is fluidly connected to a water supply unit and a gas supply unit, comprising the steps of:
after a preset condition is satisfied, moving the water supply unit to an open state to supply water into a supply pipeline of the nozzle assembly, such that water is sprayed out through a nozzle of the nozzle assembly;
moving the water supply unit from the open state to a closed state to stop supplying water into the supply pipeline;
with the water supply unit in the closed state, moving the gas supply unit to an open state to supply gas into the supply pipeline, such that gas is sprayed out through the nozzle; and
after maintaining the gas supply unit in the open state for a preset time, moving the gas supply unit to a closed state to stop supplying the gas into the supply pipeline.

19. The method of claim 18, wherein the present condition is satisfied by activating the nozzle assembly, and wherein the preset time is from 5 s to 30 s.

20. The method of claim 19, wherein the nozzle comprises a plurality of jet holes arranged in an array, and each jet hole has a diameter that is greater than 0 mm and less than or equal to 0.4 mm; and wherein water and gas can be sprayed out through each jet hole.
